(19) United States
(12) Patent Application Publication
(10) Pub. No.: US 2007/0046817 A1
(43) Pub. Date: Mar. 1, 2007

(54) Processor, processing method and processing program

(76) Inventors: Yoriko Yagi, Kyoto (JP); Manabu Kuroda, Hyogo (JP); Shigeyuki Tsunetani, Kyoto (JP); Miho Tanji, Osaka (JP)

Correspondence Address: MCDERMOTT WILL & EMERY LLP, 600 13TH STREET, N.W., WASHINGTON, DC, 20005-3096, US

(21) Appl. No.: 11/507,634

(22) Filed: Aug. 22, 2006

(30) Foreign Application Priority Data
Aug. 24, 2005 (JP) 2005-242779

(51) Int. Cl. H04N 3/27

(52) U.S. Cl. 348/554

(57) ABSTRACT

A processor in an integrated system aims to suppress the processing delay of a predetermined amount of cyclical processing that must executed. In a processor that executes processing by a round-robin method, a first processing cyclically executes a predetermined processing amount, and a second processing executes processing under a looser time constraint than the first processing. In this case, if a total processing amount of the second processing that is executed in a predetermined time period exceeds a predetermined value, execution of the second processing is suppressed in the predetermined time period, and time that was to be allocated to the second processing is instead allocated to the first processing.

### BACKGROUND OF INVENTION

1. Field of the Invention

The present invention relates to a processor that executes processing by multitasking, and in particular to a processor that multiplexes audio and video and demultiplexes multiplexed data into audio and video.

2. Related Art

Integrated systems are systems that are integrated into mass-produced products, and often include a single processor in order to reduce cost. When performing a plurality of processing operations in these integrated systems, processing is cyclically switched since there is only a single processor. In this case, it is basically desirable to raise the processing efficiency of the processor. One way of doing this is to provide a high-performance processor. However, a minimum of processing capacity is demanded for processors in integrated systems since there is also a desire to reduce cost, and the demanded processing capacity is not very high.

Such integrated systems include systems that generate encoded audio data and encoded video data according to a continuous input of audio and video, multiplex the audio data and the video data, and record or externally output the multiplexed audio and video data. One example of such a system is included in a digital video camera. Multiplexing the audio data and the video data aims to improve convenience in data transfer by handling the audio and video as a single string of data.

When performing encoding of audio, encoding of video, and multiplexing in an integrated system that includes a single processor, units of processing time are determined for the encoding of audio and video, and it is necessary to cyclically execute a predetermined amount of the audio and video encoding processing.

On the other hand, strict time constraints are not placed on multiplex processing, and it is thus sufficient to perform this processing such that the data to be processed does not overflow from the buffer. In consideration of the fact that buffer capacity is not unlimited, and that it is desirable to reduce the buffer capacity for the reason of cost, multiplex processing is performed between the cyclically executed audio encoding processing and video encoding processing. In other words, although the buffer capacity must be taken into consideration, the processing time constraint on multiplex processing is relatively looser than encoding processing.

Japanese Patent No. 3216503 discloses a multiplexed data generation apparatus that instructs timing according to which multiplexing is to be performed.

In conventional multiplexers, however, multiplexing is performed collectively once a certain amount of audio data and video data have been accumulated in a buffer.

In this case, however, a long period of time ends up being required for multiplex processing, and the encoding of audio and video data, which is supposed to be executed cyclically and finished in a predetermined time, may not finish. If this encoding is not finished, encoding of the next audio and video cannot be performed.

### SUMMARY OF INVENTION

In view of the above issue, an object of the present invention is to provide a processor that can suppress occurrences in which time-restricted processing is not executed on time, by performing processing such as multiplexing of audio data and video data between other processing that is executed cyclically.

In order to solve the above issue, a processor pertaining to the present invention includes a storage unit operable to store data to be processed; an execution unit operable to cyclically and sequentially execute first processing and second processing that have been allocated respective unit times, each instance of the first processing and the second processing being executed continually for a maximum of the respective allocated unit time, and the second processing being executed only if the data to be processed is stored in the storage unit; and a control unit operable, after a total value of a processing amount of the second processing has exceeded a predetermined value in a predetermined time period that is longer than each of the unit times, to suppress execution of the second processing in the predetermined time period and control the execution unit to execute the first processing in place of executing the second processing.

Here, “cyclically” generally refers to a plurality of processing operations being executed alternately and in order, but is a concept that may also include a case in which some processing operations are omitted.

According to this structure, a processor in an integrated system restricts the second processing according to a total processing amount of the second processing in a predetermined time period, thereby enabling the prevention of a situation in which a predetermined minimum processing amount of the cyclically and repeatedly executed first processing cannot be processed in a predetermined cycle.

Also, in performing the suppression, the control unit may use a total data amount of the second processing that has been processed by the execution unit, as the total value of the processing amount.

According to this structure, the processing amount can be determined according to the total amount of data that has been processed. Execution of the second processing is restricted according to the total amount of data thereof that has been processed, thereby enabling the prevention of the situation in which a minimum processing amount of the first processing cannot be processed in the predetermined time period.

Also, the processor may further include a monitoring unit operable, when the second processing is being executed by the execution unit, to monitor a total time for which the second processing is executed in the predetermined time period, wherein in performing the suppression, the control unit may use the total time monitored by the monitoring unit, as the total value of the processing amount.

According to this structure, the processing amount can be determined according to the total time that the second processing was executed. If it is difficult to predetermine the processing amount of the second processing, the processing amount can be determined by a total time for which the processor is occupied by the second processing, to restrict execution of the second processing. The second processing can be restricted even when the processing amount is determined according to time, thereby enabling the prevention of the situation in which a minimum processing amount of the first processing cannot be processed in the predetermined time period.

Also, the processor may further include a video encoding unit operable to receive an input of video, and encode the video to generate video data; and a multiplex unit operable to multiplex the generated video data with other data, wherein the first processing may include video encoding processing, and the second processing may include multiplex processing.

Here, the other data refers to data other than the video data, and may be, for example, audio data or subtitle data.

According to this structure, the processor executes video encoding processing as the first processing, and multiplexes the video data and the other data as the second processing. Due to the ability to encode video data and multiplex the video data with the other data, the processor can be included and utilized in a digital video camera and the like.

Also, the processor may further include an audio encoding unit operable to receive an input of audio, and encode the audio to generate audio data, wherein the other data may be the generated audio data.

According to this structure, the processor executes audio encoding processing as the first processing. Due to the ability to process audio data and video data, the processor can be included and utilized in a digital video camera and the like.

Also, the processor may further include an inference/determination unit operable to infer a data structure of data to be multiplexed by the multiplex unit, and determine the predetermined value according to the inferred data structure, wherein the control unit may suppress the multiplex processing in the predetermined time if a total amount of the multiplex processing executed by the multiplex unit exceeds, in the predetermined time period, the predetermined value determined by the inference/determination unit.

According to this structure, it is possible to infer the post-multiplex data structure of data that is to be multiplexed, and fluidly change a multiplex processing amount per predetermined time period to appropriately determine the processing amount. Although it is therefore possible for the multiplex processing amount to increase in the short-term, multiplex processing is normalized in the long-term, and the first processing will not be delayed.

Also, the processor may further include a priority determination unit operable to determine a priority for each of processing executed by the audio encoding unit, the video encoding unit and the multiplex unit, wherein if a total amount of the multiplex processing executed by the multiplex unit exceeds the predetermined value, the priority determination unit may lower the priority of the multiplex processing, and the control unit may suppress the multiplex processing according to the priorities determined by the priority determination unit.

According to this structure, it is possible to suppress the execution of the multiplex processing by lowering the priority of the second processing, which is the multiplex processing.

Also, the processor may further include a demultiplex unit operable to receive multiplexed data, and demultiplex the received multiplexed data into video data and other data; and a video decoding unit operable to receive the video data, and decode the received video data, wherein the first processing may include video decoding processing, and the second processing may include demultiplex processing.

According to this structure, the processor can separate the multiplexed data into video data and other data. If, for example, the multiplexed data includes audio data and video data, this multiplexed data is demultiplexed into the audio data and the video data. Decoding the demultiplexed video data enables viewing of the video by playback on a display or the like.

Also, the processor may further include an audio decoding unit operable to receive audio data, and decode the received audio data, wherein the other data may include the audio data, and the first processing may include audio decoding processing.

According to this structure, the processor can decode audio data, and the decoded audio can be played back from a speaker or the like.

Also, the processor may further include an analysis/determination unit operable to analyze a data structure of the multiplexed data to be demultiplexed by the demultiplex unit, and determine the predetermined value according to the analyzed data structure, wherein the control unit may suppress the demultiplex processing in the predetermined time period if a total amount of the demultiplex processing executed by the demultiplex unit exceeds, in the predetermined time period, the predetermined value determined by the analysis/determination unit.

According to this structure, the processor can analyze a structure of the multiplexed data to determine the demultiplex processing amount in the predetermined time period. Analyzing the structure of the multiplexed data makes it possible to obtain an appropriate processing time and operate without wasted time.

Also, the processor may further include a priority determination unit operable to determine a priority for each of processing executed by the audio decoding unit, the video decoding unit and the demultiplex unit, wherein if a total amount of the demultiplex processing executed by the demultiplex unit exceeds the predetermined value, the priority determination unit may lower the priority of the demultiplex processing, and the control unit may suppress the demultiplex processing according to the priorities determined by the priority determination unit.

According to this structure, the processor can suppress the execution of the demultiplex processing by lowering the priority thereof.

Also, if the first processing is not present after the second processing has been suppressed in the predetermined time period, the control unit may cancel the suppression and execute the second processing in the predetermined time period.

According to this structure, the processor executes the second processing if there is no longer any first processing, even if the second processing is suppressed. It is therefore possible to even more efficiently execute processing in the processor.

Also, the present invention is a processing method in a processor that executes a plurality of processing operations, the processing method including a storage step of storing data to be processed; an execution step of cyclically and sequentially executing first processing and second processing that have been allocated respective processor occupancy times, each instance of the first processing and the second processing being executed for a maximum of the respective allocated processor occupancy time, and the second processing being executed only if the data to be processed is stored in the storage step; and a control step of, after a total value of a processing amount of the sequentially executed second processing has exceeded a predetermined value in a predetermined time period, suppressing execution of the second processing in the predetermined time period and performing control such that the first processing is executed in place of execution of the second processing.

According to this method, the processor can maintain a minimum amount of the first processing in the predetermined time by suppressing the second processing.

Also, the present invention is a processing program indicating a processing procedure for causing a processor to execute a plurality of processing, the processing procedure including a storage step of storing data to be processed; an execution step of cyclically and sequentially executing first processing and second processing that have been allocated respective processor occupancy times, each instance of the first processing and the second processing being executed for a maximum of the respective allocated processor occupancy time, and the second processing being executed only if the data to be processed is stored in the storage step; and a control step of, after a total value of a processing amount of the sequentially executed second processing has exceeded a predetermined value in a predetermined time period, suppressing execution of the second processing in the predetermined time period and performing control such that the first processing is executed in place of execution of the second processing.

Reading and executing this program enables the processor to maintain a minimum amount of the first processing in the predetermined time by suppressing the second processing.

### BRIEF DESCRIPTION OF DRAWINGS

These and other objects, advantages, and features of the invention will become apparent from the following description thereof taken in conjunction with the accompanying drawings, which illustrate specific embodiments of the present invention.

In the drawings:

FIG. 1 is a block diagram showing a functional structure of a multiplexer 100 according to embodiment 1;

FIG. 2 is a block diagram showing a functional structure of a demultiplexer 200 according to embodiment 1;

FIG. 3 is a timing chart showing exemplary timing of processing executed by a multiplexer;

FIG. 4 is a timing chart showing exemplary timing of processing executed by a demultiplexer;

FIG. 5 is a flowchart showing operations of the multiplexer 100;

FIG. 6 is a flowchart showing operations of the demultiplexer 200;

FIG. 7 is a block diagram showing a functional structure of a multiplexer 700 according to embodiment 2;

FIG. 8 is a block diagram showing a functional structure of a demultiplexer 800 according to embodiment 2;

FIG. 9 is a flowchart showing operations of the multiplexer 700;

FIG. 10 is a flowchart showing operations of the demultiplexer 800;

FIG. 11 is a block diagram showing a functional structure of a multiplexer 1100 according to embodiment 3;

FIG. 12 is a block diagram showing a functional structure of a demultiplexer 1200 according to embodiment 3;

FIGS. 13A and 13B are conceptual views of data streams showing exemplary structures of multiplexed data;

FIG. 14 is a flowchart showing operations of the multiplexer 1100;

FIG. 15 is a flowchart showing operations of the demultiplexer 1200;

FIG. 16 is a block diagram showing a functional structure of a multiplexer 1600 according to embodiment 4;

FIG. 17 is a block diagram showing a functional structure of a demultiplexer 1700 according to embodiment 4;

FIG. 18 is a flowchart showing operations of the multiplexer 1600;

FIG. 19 is a flowchart showing operations of the demultiplexer 1700;

FIG. 20 is a block diagram showing a functional structure of a multiplexer 2000;

FIG. 21 is a block diagram showing a functional structure of a demultiplexer 2100;

FIG. 22 is a flowchart showing operations of the multiplexer 2000; and

FIG. 23 is a flowchart showing operations of the demultiplexer 2100.

### DETAILED DESCRIPTION OF PREFERRED EMBODIMENTS

Embodiments of the present invention are described below with reference to the drawings.

### Embodiment 1

In embodiment 1, multiplex processing and demultiplex processing are suppressed according to a predetermined data amount in a predetermined time period.

Structure

Structure of a Multiplexer

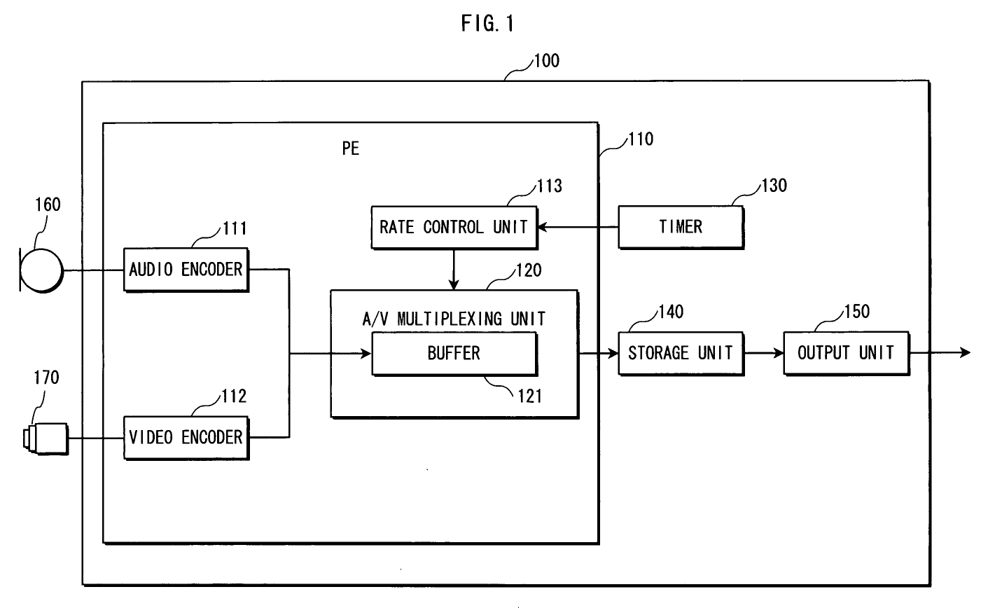

First, the following describes a functional structure of a multiplexer of embodiment 1 using the functional block diagram of FIG. 1.

As shown in FIG. 1, a multiplexer 100 includes a PE (Processor Element) 110, a timer 130, a storage unit 140 and an output unit 150.

The PE 110 is a processor that executes processing by multitasking, and includes an audio encoder 111, a video encoder 112, a rate control unit 113, and an A/V (audio/video) multiplexing unit 120.

The audio encoder 111 receives audio input from a microphone 160, and encodes the audio input to generate encoded audio data. The audio encoder 111 also outputs the generated audio data to a buffer 121 of the A/V multiplexing unit 120.

The video encoder 112 receives video input from a camera 170, and encodes the video input to generate encoded video data. The video encoder 112 also outputs the generated video data to the buffer 121 of the A/V multiplexing unit 120.

The rate control unit 113 stores a predetermined value corresponding to a maximum data amount that can be processed by the A/V multiplexing unit 120 in 33 msec, and suppresses multiplex processing in the A/V multiplexing unit 120 if the amount of data processed by the A/V multiplexing unit 120 exceeds the maximum data amount.

With the exception of the rate control unit 113, the PE 110 cyclically executes processing of the audio encoder 111, the video encoder 112 and the A/V multiplexing unit 120 for a maximum of a time allocated for each instance of processing.

The A/V multiplexing unit 120 includes the buffer 121. The A/V multiplexing unit 120 multiplexes the audio data and the video data stored in the buffer 121. This “multiplexing” refers to combining audio data and video data into a single data stream. Synchronization information that indicates which parts of the data stream correspond to the audio data and the video data is also multiplexed into the data stream, such that the audio and video data can be played back in synchronization. The A/V multiplexing unit 120 also receives a notification from the rate control unit 113, and, according to the received notification, suppresses multiplex processing or cancels the suppression.

The buffer 121 is a memory for storing the audio data and the video data. Note that the A/V multiplexing unit 120 does not perform multiplexing unless a predetermined amount of data or more is accumulated in the buffer 121.

If a multiplex bitrate is 10 Mbps, 41250 bytes of data is multiplexed in 33 msec. Expressed in numbers of packets, this is 20 packs (assuming 1 pack=2048 bytes). Also, if the multiplex bitrate is 2 Mbps, the processing data volume is 8250 bytes, which is 4 packs when converted to processing packets.

The timer 130 clocks elapsed time and, when a countdown from 33 msec reaches 0, notifies the rate control unit 113 that 33 msec has elapsed. When the countdown reaches 0, the timer 130 also resets the count to 33 msec and again performs the countdown.

The storage unit 140 is a memory that stores multiplexed data generated by the A/V multiplexing unit 120, and is realized by, for example, a hard disk.

The output unit 150 outputs the multiplexed data stored in the storage unit 140 to an external device.

Structure of a Demultiplexer

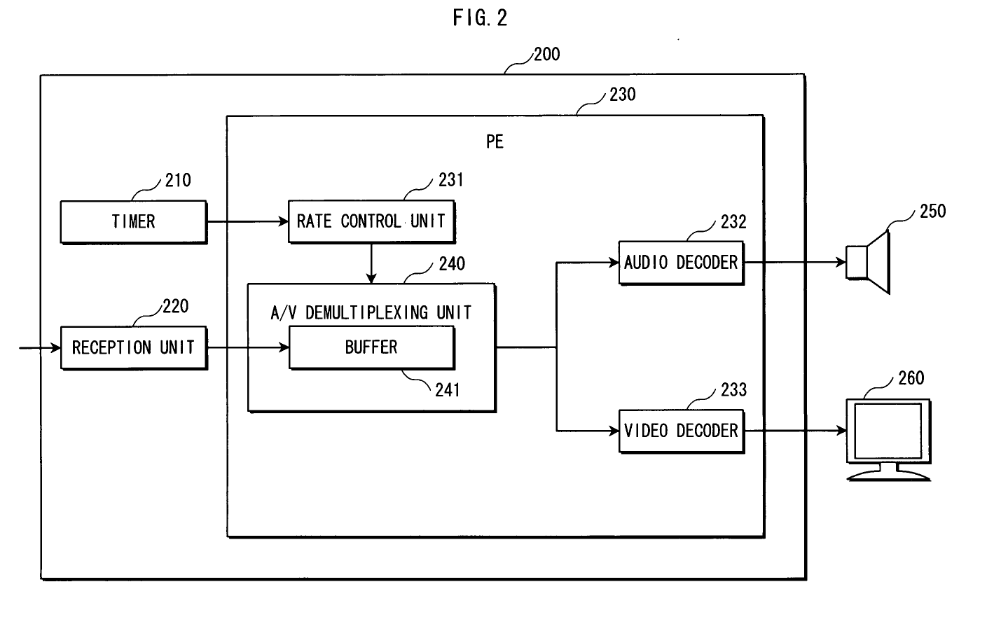

FIG. 2 shows a functional structure of a demultiplexer that receives multiplexed data and separates the multiplexed data into audio data and video data, such that audio and video can be played back.

As shown in FIG. 2, a demultiplexer 200 includes a timer 210, a reception unit 220 and a PE 230.

The timer 210 clocks elapsed time and, when a countdown from 33 msec reaches 0, notifies a rate control unit 231 that 33 msec has elapsed. When the countdown reaches 0, the timer 210 also resets the count to 33 msec and again performs the countdown.

The reception unit 220 receives multiplexed data from an external device, and outputs the received multiplexed data to a buffer 241 of an A/V demultiplexing unit 240.

The PE 230 includes the rate control unit 231, the A/V demultiplexing unit 240, an audio decoder 232 and a video decoder 233. The PE 230 is a processor that executes processing by multitasking.

The rate control unit 231 prestores a predetermined value corresponding to a data amount to be processed by the A/V demultiplexing unit 240 in a period of 33 msec, and suppresses demultiplexing processing performed by the A/V demultiplexing unit 240 according to the predetermined value.

The A/V demultiplexing unit 240 includes the buffer 241 and demultiplexes received multiplexed data into audio data and video data based on an instruction of the rate control unit 231. The A/V demultiplexing unit 240 outputs the demultiplexed audio data and video data along with the synchronization information to the audio decoder 232 and the video decoder 233. The A/V demultiplexing unit 240 also receives a notification from the rate control unit 231, and, according to the received notification, suppresses demultiplex processing or cancels the suppression.

The audio decoder 232 decodes the audio data and outputs the decoded audio data to a speaker 250.

The video decoder 233 decodes the video data and outputs the decoded video data to a display 260.

Note that the audio decoder 232 and the video decoder 233 output data based on the synchronization information such that the output audio and video are played back in synchronization by the speaker 250 and the display 260.

Operation

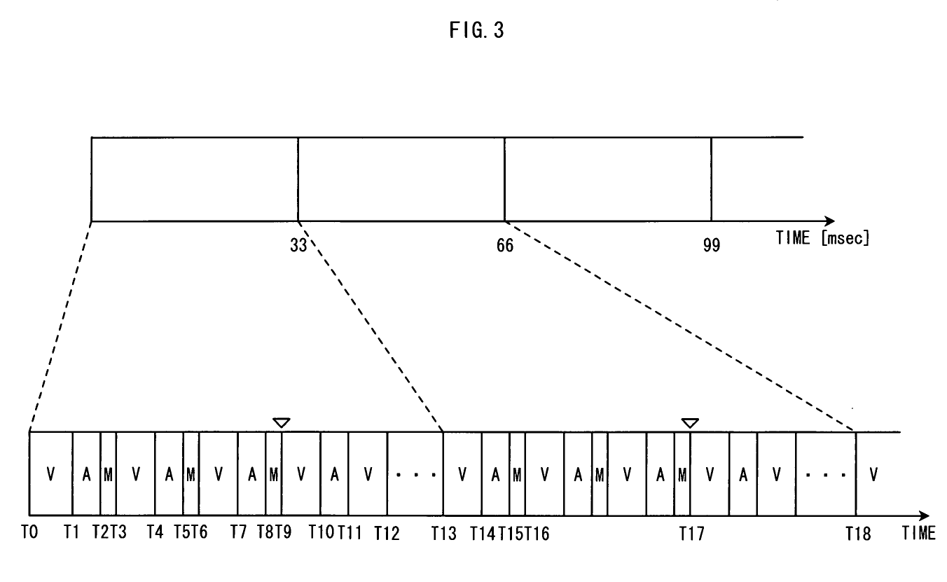

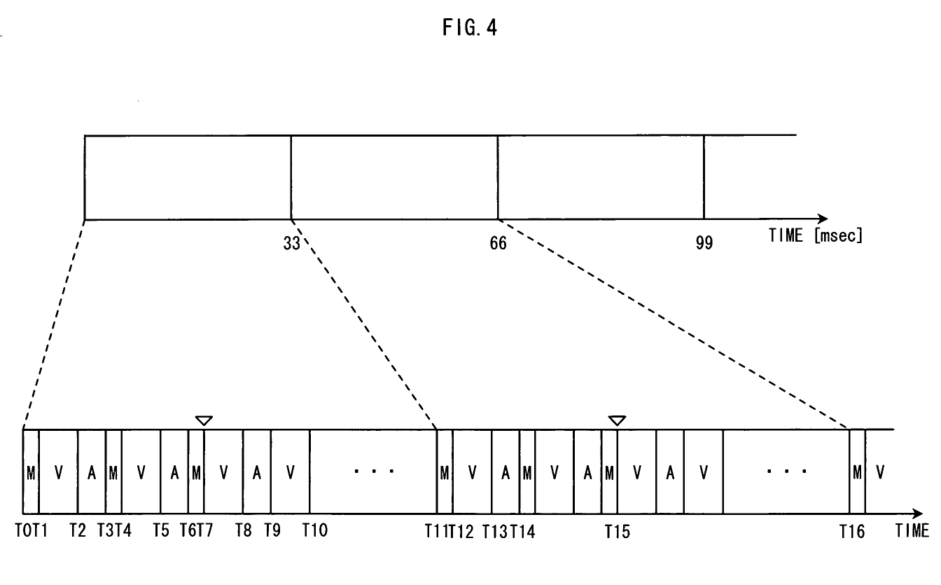

First, the following conceptually describes processing performed by the multiplexer 100 and the demultiplexer 200 of the present embodiment using the timing charts of FIG. 3 and FIG. 4.

Timing Chart of Processing Performed by the Multiplexer

FIG. 3 shows processing performed by the multiplexer 100. The multiplexer 100 repeatedly performs tasks on the order of 33 msec. In FIG. 3, video encoding processing is shown by “V”, audio encoding processing is shown by “A”, and multiplex processing is shown by “M”. Here, to aid in understanding of features of the present invention, the buffer 121 is assumed to always have the predetermined amount of data or more accumulated.

Video encoding processing is performed from time T0 to T1. Audio encoding processing is performed from time T1 to T2. Multiplex processing is performed from time T2 to T3. Video encoding processing is again performed from time T3 to T4. Audio encoding processing is again performed from time T4 to T5. Multiplex processing is again performed from time T5 to T6. In this way, the PE 110 of the multiplexer 100 cyclically and repeatedly performs video encoding processing, audio encoding processing and multiplex processing.

Video encoding processing is performed from T6 to T7, audio encoding processing is performed from T7 to T8, and multiplex processing is performed from T8 to T9. Here, multiplex processing is suppressed from being further performed in the 33-msec period when the amount of multiplex processing exceeds the predetermined value determined by the rate control unit 113, which corresponds to the maximum amount of data to be processed by the A/V multiplexing unit in 33 msec. As shown in FIG. 3, video encoding processing and audio encoding processing are repeatedly performed from T9 to T13, that is to say, video encoding processing is performed from T9 to T10, audio encoding processing is performed from T10 to T11, video encoding processing is performed from T11 to T12, and so on.

When processing moves to the next 33-msec period, suppression of the multiplex processing is cancelled, and multiplex processing is again performed, as shown in T15 to T16.

Note that video encoding processing, audio encoding processing and multiplex processing are performed on the order of tens to hundreds of μsec at a ratio of approximately 6:3:1. Also, in FIG. 3 a triangle (∇) shows a timing of the suppression of the multiplex processing in the 33-msec period. In other words, T9 is when the amount of multiplex processing has exceeded the predetermined value determined by the rate control unit 113.

Time Chart of Processing Performed by the Demultiplexer

On the other hand, FIG. 4 shows processing performed by the demultiplexer 200.

As shown in FIG. 4, the demultiplexer 200 also repeatedly performs processing on the order of 33 msec. Here, demultiplex processing is shown by “M”, video decoding processing is shown by “V”, and audio decoding processing is shown by “A”. Also, the buffer 241 is assumed to have a predetermined amount or more of multiplexed data for demultiplexing accumulated.

Demultiplex processing is performed from time T0 to T1. Video decoding processing is performed from time T1 to T2. Audio decoding processing is performed from time T2 to T3. Demultiplex processing is again performed from time T3 to T4. Video decoding processing is again performed from time T4 to T5. Audio decoding processing is again performed from time T5 to T6. In this way, the PE 230 of the demultiplexer 200 cyclically and repeatedly performs demultiplex processing, video decoding processing and audio decoding processing.

Demultiplex processing is performed from T6 to T7. T7 is the point when the demultiplex processing amount exceeds the predetermined value determined by the rate control unit 231. Video decoding processing is performed from T7 to T8, and audio decoding processing is performed from T8 to T9. Demultiplex processing would have been performed from T9 to T10, but video decoding processing is performed instead. Until the 33-msec period has elapsed, demultiplex processing is suppressed from being further performed, and video decoding processing and audio decoding processing are cyclically executed.

When the 33-msec period has elapsed at T11, and processing moves to the next 33-msec period, demultiplex processing is again performed, as shown in T11 to T12.

Note that video decoding processing, audio decoding processing and demultiplex processing are performed on the order of for tens to hundreds of μsec at a ratio of approximately 6:3:1. Also, a triangle (∇) in FIG. 4 shows a timing of the suppression of the demultiplex processing in the 33-msec period. In other words, T7 is when the amount of multiplex processing exceeded the predetermined value determined by the rate control unit 231.

A large feature of the present invention involves suppressing multiplex processing or demultiplex processing if a processing amount thereof in a certain period (here, 33 msec) exceeds a predetermined value.

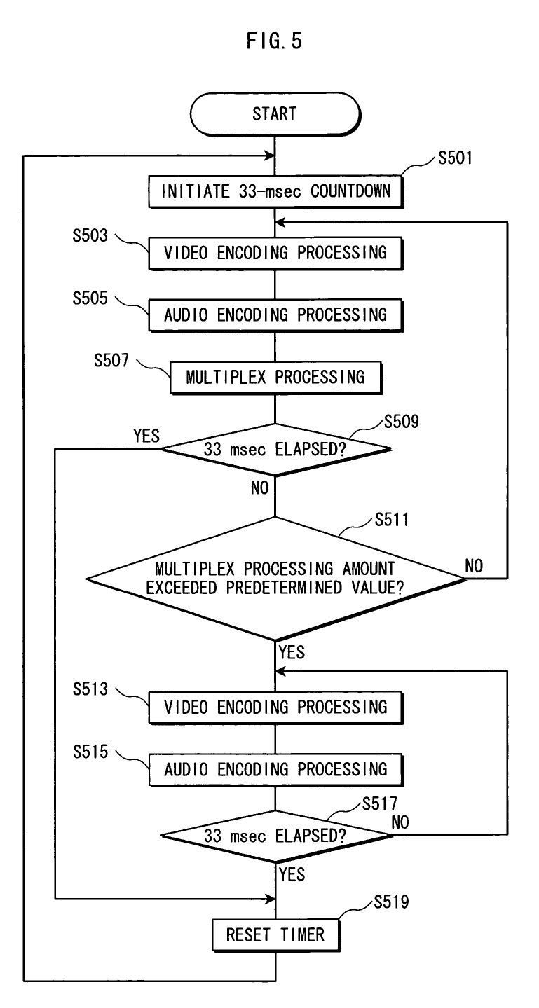

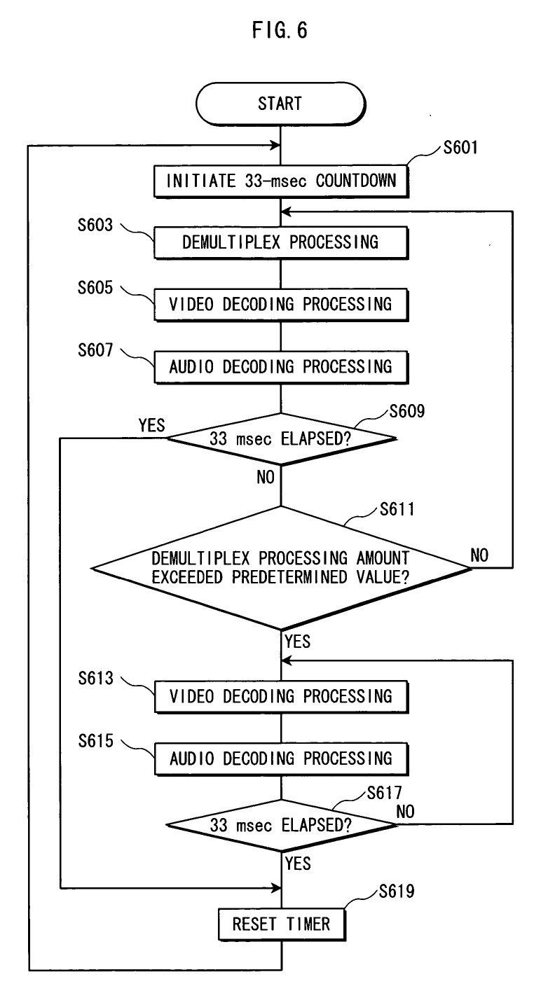

Next is a description of operations of the multiplexer 100 and the demultiplexer 200 pertaining to embodiment 1 using the flowcharts of FIG. 5 and FIG. 6 respectively.

Operations of the Multiplexer

FIG. 5 shows operations of the multiplexer 100.

First, the timer 130 of the multiplexer 100 initiates a 33-msec countdown that decrements a count from 33 (step S501). The video encoder 112 of the PE 110 encodes video to generate encoded video data, and stores the encoded video data in the buffer 121 of the A/V multiplexing unit 120 (step S503). When a single period of time allocated to video encoding has elapsed, the audio encoder 112 next encodes audio to generate encoded audio data, and stores the encoded audio data in the buffer 121 (step S505). When a single period of time allocated to audio encoding has elapsed, the A/V multiplexing unit 120 next multiplexes the video data and audio data stored in the buffer 121, in the order of storage (step S507).

The rate control unit 113 checks whether a notification that 33 msec has elapsed has been received from the timer 130 (step S509). If the notification has been received, the count of the timer 130 is reset to 33 msec (step S519), and processing returns to step S501.

If 33 msec has not elapsed (step S509:NO), the rate control unit 113 judges whether the amount of data multiplexed by the A/V multiplexing unit 120 exceeds the predetermined value stored by the rate control unit 113 (step S511). If the predetermined value has not been exceeded (step S511:NO), processing returns to step S503, and the multiplexer 100 executes subsequent processing.

If the amount of multiplexed data exceeds the predetermined value stored by the rate control unit 113 (step S511:YES), the rate control unit 113 notifies the A/V multiplexing unit 120 to suppress multiplex processing for a remainder of the 33-msec period, whereby the A/V multiplexing unit 120 suppresses the multiplex processing.

The PE 110 performs video encoding processing (step S513) and performs audio encoding processing (step S515). If the notification that 33 msec has elapsed has not been received from the timer 130 (step S517:NO), processing returns to step S513, and subsequent processing is executed.

If the notification that 33 msec has elapsed has been received from the timer 130 (step S517:YES), the rate control unit 113 cancels the suppression of multiplex processing in the A/V multiplexing unit 120. Also, the timer 130 resets the count to 33 msec (step S519), processing returns to step S501, and subsequent processing is executed.

This processing is executed as long as audio and video are input from the microphone 160 and the camera 170.

Operations of the Demultiplexer

FIG. 6 is a flowchart showing operations of the demultiplexer 200.

As shown in FIG. 6, the demultiplexer 200 receives multiplexed data from a multiplexer via the reception unit 220. The received data is sequentially stored in the buffer 241.

The timer 210 initiates a 33-msec countdown (step S601). When the received multiplexed data is accumulated in the buffer, the A/V demultiplexing unit 240 performs demultiplex processing (step S603). Encoded video data that resulted from the demultiplex processing is decoded by the video decoder 233 (step S605) After the time allocated to the decoding processing has elapsed, the audio decoder 232 decodes encoded audio data that resulted from the demultiplex processing (step S607). The rate control unit 231 then checks whether the notification that 33 msec has elapsed has been received from the timer 210 (step S609).

If the rate control unit 231 has received the notification from the timer 210 (step S609:YES), processing moves to step S619, and subsequent processing is executed. If the notification has not been received (step S609:NO), the rate control unit 231 judges whether the total amount of demultiplexed data exceeds the predetermined value stored in the rate control unit 231 (step S611).

If the total amount of demultiplexed data does not exceed the predetermined value (step S611:NO), processing returns to step S603, and subsequent processing is executed. If the total amount of demultiplexed data exceeds the predetermined value (step S611:YES), the rate control unit 231 notifies the A/V demultiplexing unit 240 to suppress demultiplex processing, whereby the A/V demultiplexing unit 240 suppresses the demultiplex processing.

Then, the video decoder 233 performs video decoding processing (step S613). After video decoding has been performed, the audio decoder 232 decodes the audio data (step S615). Note that the audio decoder 232 and the video decoder 233 output audio and video respectively such that the audio and video are played back in synchronization.

The rate control unit 231 checks whether the notification that 33 msec has elapsed has been received from the timer 210 (step S617). If 33 msec has not elapsed (step S617:NO), processing returns to step S613, and subsequent processing is executed. If 33 msec has elapsed (step S617:YES), the rate control unit 231 cancels the suppression of demultiplex processing in the A/V demultiplexing unit 240. Also, the timer 210 resets the count to 33 msec (step S619). Processing returns to step S601, and subsequent processing is again executed.

This series of processing is repeatedly executed as long as multiplexed data is received by the reception unit 220.

### Embodiment 2

In embodiment 2, multiplex processing and demultiplex processing are suppressed according to time, unlike embodiment 1 in which multiplex processing and demultiplex processing are suppressed by the rate control unit according to an amount of data that has been processed. Embodiment 1 illustrates a case in which the amount of data to be multiplexed per period of time is fixed, that is, a case in which it is possible to predict an amount of data to be multiplexed. If the data to be multiplexed is variable bitrate data, however, it is difficult to set an amount of data to be processed as the predetermined value in the rate control unit, since predicting this value is difficult. Embodiment 2 has been achieved in view of such a situation in which an amount of data to be processed cannot be predetermined.

Structure

Structure of a Multiplexer

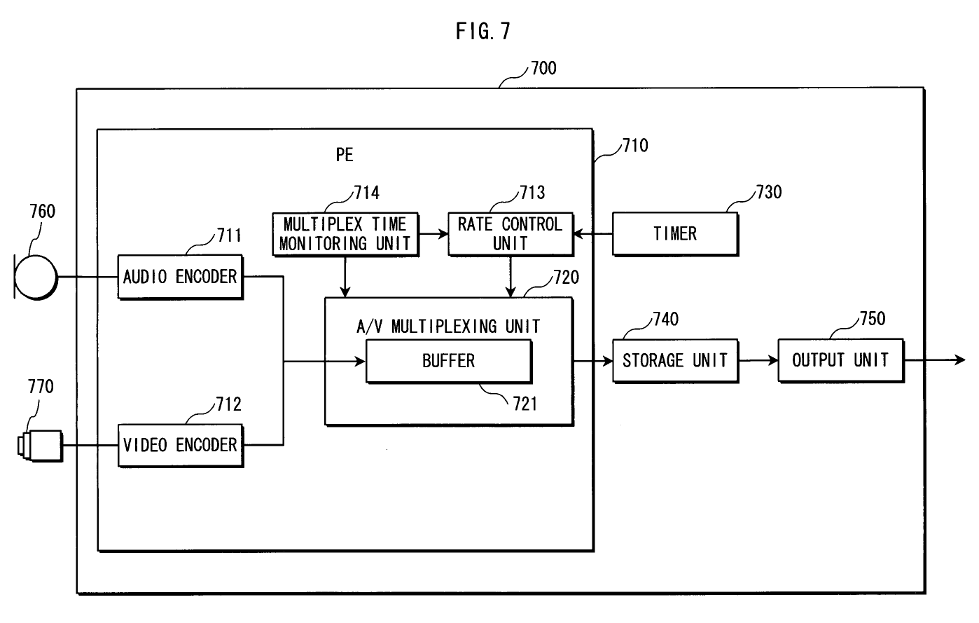

FIG. 7 is a block diagram showing a functional structure of a multiplexer 700 pertaining to embodiment 2. The fundamental structure of the multiplexer 700 is the same as the structure of the multiplexer 100, and units with the same names have functions pursuant to those in the multiplexer 100. Descriptions of units with the same names and functions are therefore omitted, and only units differing from the multiplexer 100 are described below.

Unlike the multiplexer. 100, the multiplexer 700 includes a multiplex time monitoring unit 714.

The multiplex time monitoring unit 714 monitors a total time for which an A/V (audio/video) multiplexing unit 720 performs multiplex processing, and sequentially notifies the total time to a rate control unit 713.

The rate control unit 713 stores a total time for which the A/V multiplexing unit 720 may perform multiplex processing in a 33-msec period. Also, the rate control unit 713 compares the time output from the multiplex time monitoring unit 714 and the stored total time, and notifies the A/V multiplexing unit 720 to suppress multiplexing of audio data and video data when the output time exceeds the total time.

Structure of a Demultiplexer

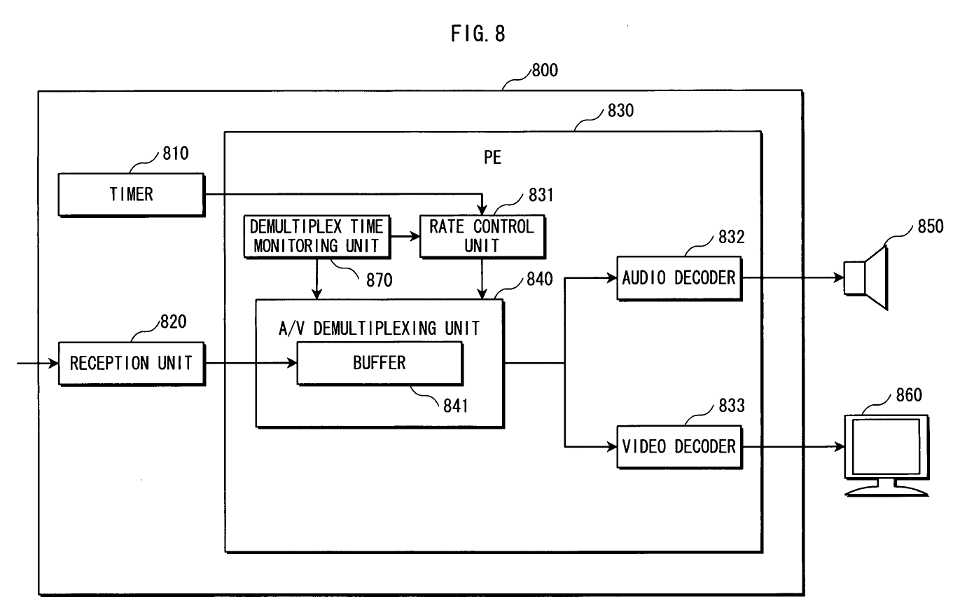

FIG. 8 is a block diagram showing a functional structure of a demultiplexer 800 pertaining to embodiment 2. The fundamental structure of the demultiplexer 800 is the same as the structure of the demultiplexer 200, and units with the same names have functions pursuant to those in the demultiplexer 200. Descriptions of units with the same names and functions are therefore omitted, and only units differing from the demultiplexer 200 are described below.

Unlike the demultiplexer 200, the demultiplexer 800 includes a demultiplex time monitoring unit 870.

The demultiplex time monitoring unit 870 monitors a total time for which an A/V demultiplexing unit 840 performs demultiplex processing, and notifies the total time to a rate control unit 831.

The rate control unit 831 stores, as a predetermined value, a total time for which the A/V demultiplexing unit 840 may demultiplex multiplexed data. The rate control unit 831 also compares the time output from the demultiplex time monitoring unit 870 and the stored predetermined value, and notifies the A/V demultiplexing unit 840 to suppress demultiplex processing of multiplexed data when the output time exceeds the predetermined value.

Operations

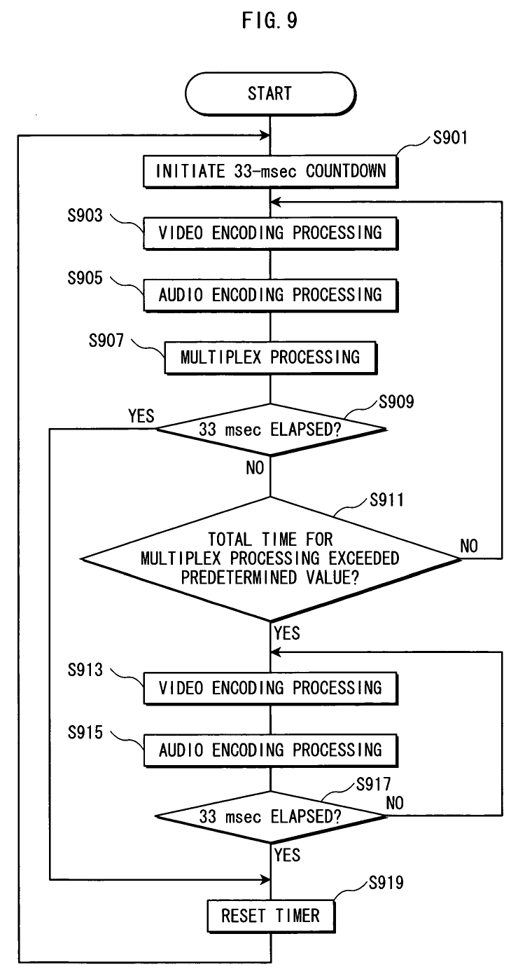

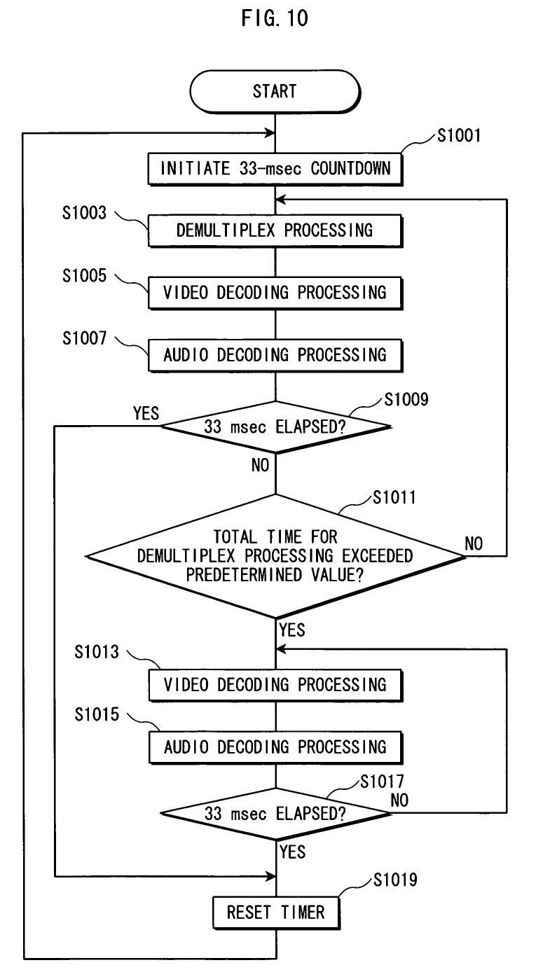

The following describes operations of the multiplexer 700 and the demultiplexer 800 using the flowcharts of FIG. 9 and FIG. 10 respectively.

Operations of the Multiplexer

First is a description of operations of the multiplexer 700.

A timer 730 of the multiplexer 700 initiates a 33-msec countdown (step S901).

A video encoder 712 of a PE 710 receives video input from a camera 770, and encodes the video input to generate encoded video data (step S903). The generated encoded video data is sequentially output to a buffer 721 and accumulated therein.

An audio encoder 711 receives audio input from a microphone 760, and encodes the audio input to generate encoded audio data (step S905). The generated encoded audio data is sequentially output to the buffer 721 and accumulated therein.

The A/V multiplexing unit 720 multiplexes the video data and the audio data that are accumulated in the buffer 721 (step S907).

The rate control unit 713 checks whether a notification that 33 msec has elapsed has been received from the timer 730 (step S909). If 33 msec has elapsed (step S909:YES), the timer 730 resets the count to 33 msec (step S919), and processing returns to step S901. If 33 msec has not elapsed (step S909:NO), the rate control unit 713 judges whether the total time for which the A/V multiplexing unit 720 performed multiplex processing exceeds the predetermined value stored in the rate control unit 713 (step S911). If the total time for multiplex processing has not exceeded the predetermined value (step S911:NO), processing returns to step S903, and subsequent processing is executed. If the total time for multiplex processing exceeds the predetermined value (step S911:YES), the rate control unit 713 notifies the A/V multiplexing unit 720 to suppress multiplex processing for a remainder of the 33-msec period, whereby the A/V multiplexing unit 720 suppresses the multiplex processing.

The video encoder 712 encodes video to generate video data (step S913). The audio encoder 711 encodes audio to generate audio data (step S915).

The rate control unit 713 checks whether the notification that 33 msec has elapsed has been received from the timer 730 (step S917). If 33 msec has not elapsed (step S917:NO), processing returns to step S913, and subsequent processing is executed. If 33 msec has elapsed (step S917:YES), the rate control unit 713 notifies the A/V multiplexing unit 720 to cancel the suppression of multiplex processing. The timer 730 resets the count to 33 msec (step S919), and the multiplexer 700 moves to the next 33-msec cycle.

This processing is executed as long there is audio input and/or video input from a microphone 760 and a camera 770 respectively.

Operations of the Demultiplexer

Next is a description of operations of the demultiplexer 800.

FIG. 10 is a flowchart showing operations of the demultiplexer 800.

As shown in FIG. 10, the demultiplexer 800 receives, via a reception unit 820, multiplexed data from, for example, a multiplexer. The demultiplexer 800 sequentially stores the received multiplexed data in a buffer 841.

A timer 810 initiates a 33-msec countdown (step S1001). The A/V demultiplexing unit 840 performs demultiplex processing when a predetermined amount of the received multiplexed data is accumulated in the buffer 841 (step S1003). Demultiplexed video data is decoded by a video decoder 833 (step S1005). After the time allocated to the decoding processing has elapsed, the audio decoder 832 decodes demultiplexed audio data (step S1007). The rate control unit 831 checks whether the notification that 33 msec has elapsed has been received from the timer 810 (step S1009).

If the rate control unit 831 has received the notification from the timer 810 (step S1009:YES), processing moves to step S1019, and subsequent processing is executed. If the notification has not been received (step S1009:NO), the rate control unit 831 judges whether the total time of demultiplex processing exceeds the predetermined value stored in the rate control unit 231 (step S1011).

If the total time of demultiplex processing has not exceeded the predetermined value (step S1011:NO), processing returns to step S1003, and subsequent processing is executed. If the total time of demultiplex processing exceeds the predetermined value (step S1011:YES), the rate control unit 831 notifies the A/V demultiplexing unit 840 to suppress demultiplex processing, whereby the A/V demultiplexing unit 840 suppresses the demultiplex processing.

Then, the video decoder 833 performs video decoding processing (step S1013). After video decoding has been performed, the audio decoder 832 performs audio decoding processing (step S1015). Note that the audio decoder. 832 and the video decoder 833 output audio and video respectively such that the audio and video are played back in synchronization.

The rate control unit 831 checks whether the notification that 33 msec has elapsed has been received from the timer 810 (step S1017). If 33 msec has not elapsed (step S1017:NO), processing returns to step S1013, and subsequent processing is executed. If 33 msec has elapsed (step S1017:YES), the rate control unit 831 cancels the suppression of demultiplex processing in the A/V demultiplexing unit 840. Also, the timer 810 resets the count to 33 msec (step S1019). Processing returns to step S1001, and subsequent processing is again executed.

This series of processing is repeatedly executed as long as multiplexed data is received by the reception unit 820.

### Embodiment 3

Unlike embodiments 1 and 2, embodiment 3 discloses a multiplexer and a demultiplexer that set a predetermined value for a processing amount, based on a structure of data to be multiplexed and a structure of multiplexed data.

Structure

Structure of a Multiplexer

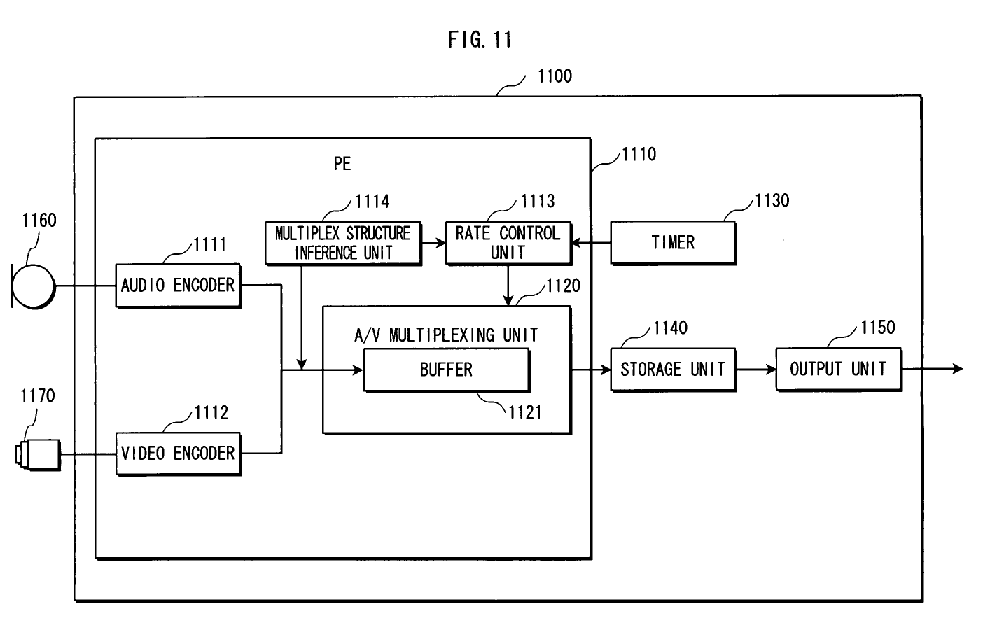

FIG. 11 is a block diagram showing a functional structure of a multiplexer 1100 pertaining to embodiment 3.

Unlike the multiplexer 100, the multiplexer 1100 includes a multiplex structure inference unit 1114.

The multiplex structure inference unit 1114 monitors a signal line that connects an audio encoder 1111 and a video encoder 1112 to a buffer 1121. The multiplex structure inference unit 1114 uses a data size and ordering of audio data and video data transmitted on the signal line to infer a structure (I/P/B-VOP, Padding, etc.) of multiplexed data to be generated by an A/V multiplexing unit 1120, and, based on the inferred structure, calculates a total processing amount, which is an amount of data that may be multiplexed in a 33-msec period, and notifies the total processing amount to a rate control unit 1113.

The following describes a method of calculating the total processing amount based on the structure of data to be multiplexed.

Multiplex data resulting from multiplex processing is generated in units of packets. A maximum data volume of a single packet is determined in advance, and a volume of audio data or video data included in a single packet is of course determined accordingly. Given that a determined volume of audio data or video data is included in a single packet, it is possible to roughly reverse calculate a time required for multiplexing the audio and video data. A total value corresponding to an amount of data that may be multiplexed in 33 msec is calculated from the reverse-calculated time and a total time for which a minimum amount of audio encoding processing and video encoding processing must be performed in 33 msec. Specifically, the total time for audio encoding processing and video encoding processing is subtracted from 33 msec, and the resulting time is compared with the reverse-calculated time. The shorter of the two compared times is used to determine the predetermined value corresponding to the multiplex processing amount. Consequently, amounts of data to be multiplexed in the 33 msec periods are basically different each time.

The rate control unit 1113 sets, as the predetermined value, the data amount notified from the multiplex structure inference unit 1114, and notifies the A/V multiplexing unit 1120 to suppress multiplex processing when the amount of multiplexed data reaches the predetermined value. Once 33 msec has elapsed, the suppression of multiplex processing is cancelled.

Structure of a Demultiplexer

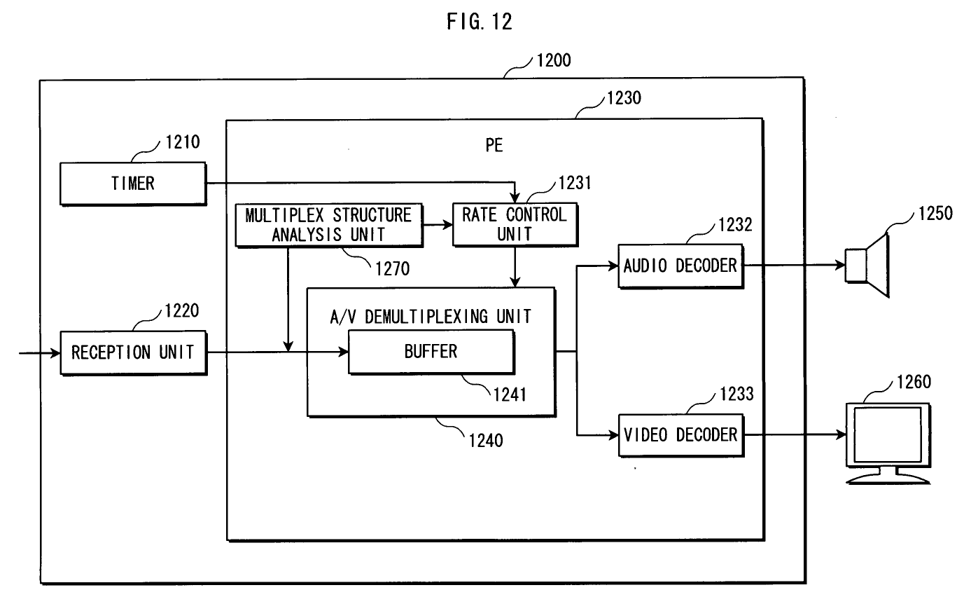

FIG. 12 is a block diagram showing a functional structure of a demultiplexer 1200 pertaining to embodiment 3.

Unlike the demultiplexer 200, the demultiplexer 1200 includes a multiplex structure analysis unit 1270.

The multiplex structure analysis unit 1270 analyzes multiplexed data that is received by a reception unit 1220 and transmitted to a buffer 1241. Here, analysis of multiplexed data refers to analyzing a sequence structure of the multiplexed data stream, and analysis is performed from a beginning of the data accumulated in the buffer. It is therefore possible to know a data sequence of audio data and video data to be generated by demultiplex processing.

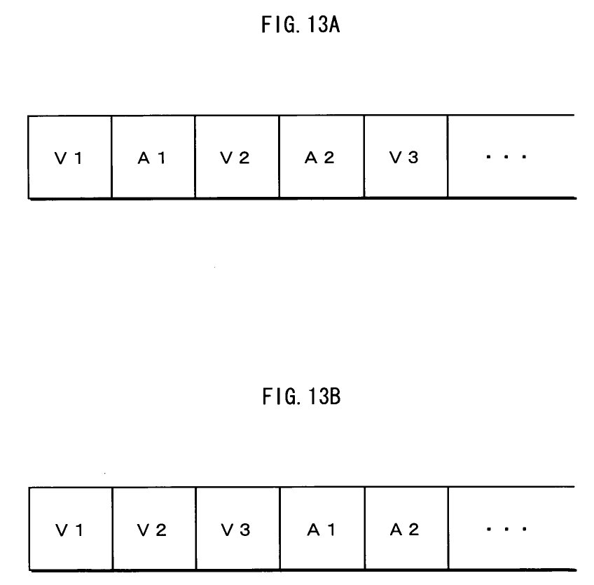

FIGS. 13A and 13B show frame format structures of multiplexed data. In FIGS. 13A and 13B, the video data is shown by “V1”, “V2” and “V3”, and the audio data is shown by “A1” and “A2”. Here, video data V1 and audio data A1 are synchronized, as well as video data V2 and audio data A2. In other words, playback cannot be properly performed if the audio data and video data are not synchronized in correspondence with each other, and only video or audio will be played back if corresponding data is not available.

Although it is preferable for the multiplexed data to be multiplexed in order as in FIG. 13A, in actuality, the data sequence is often out of order as shown in FIG. 13B. Therefore, if the multiplexed data has the structure as shown in FIG. 13B, “A1” and “V1” cannot be played back in synchronization without demultiplexing at least to audio data “A1”. In this case, one instance of demultiplex processing includes up to “A1”.

Here, the multiplex structure analysis unit 1270 judges how much data must be demultiplexed in 33 msec such that video and audio can be played back in synchronization by a display 1260 and a speaker 1250, determines a data processing amount for 33 msec, and sequentially notifies a data processing amount for each 33-msec period to the rate control unit 1231.

The rate control unit 1231 sets the notified data processing amount as the predetermined value, and notifies the A/V demultiplexing unit 1240 to suppress demultiplex processing. The rate control unit 1231 cancels the suppression when 33 msec has elapsed.

Operations

Operations of the Multiplexer

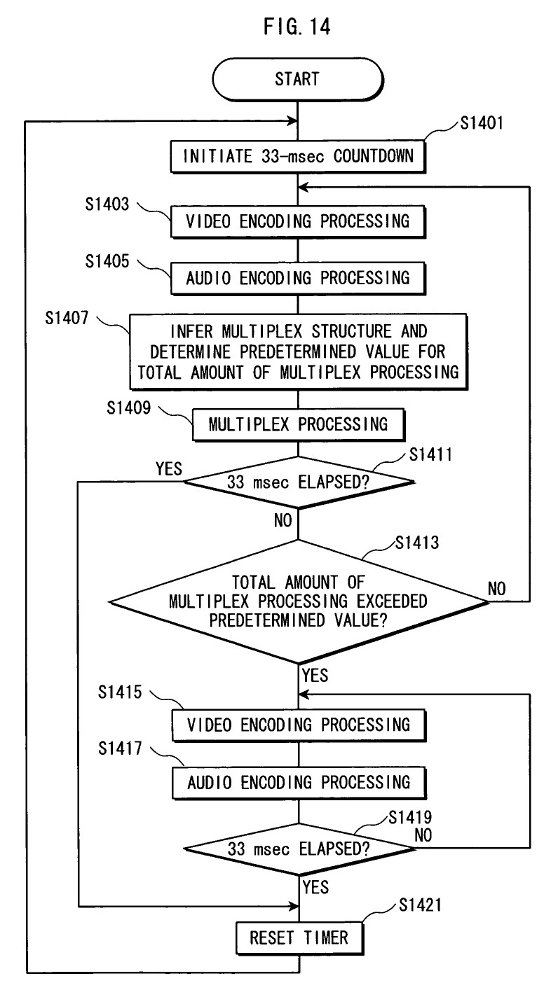

FIG. 14 is a flowchart showing operations of the multiplexer 1100.

As shown in FIG. 14, the multiplexer 1100 first acquires audio from a microphone and video from a video camera. At the same time, the timer 1130 initiates a 33-msec countdown (step S1401).

The acquired video is encoded by the video encoder 1112 to generate encoded video data (step S1403). Next, the audio acquired from the microphone is encoded by the audio encoder 1111 to generate encoded audio data (step S1405). The encoded video data and audio data are then accumulated in the buffer 1121. The multiplex structure inference unit 1114 monitors the signal line connecting the audio encoder 1111 and the video encoder 1112 to the buffer 1121, infers a structure of the data to be multiplexed, and determines the predetermined value for multiplex processing (step S1407). The predetermined value is set in the rate control unit 1113 as the total value for multiplex processing. The data accumulated in the buffer 1121 is multiplexed by the A/V multiplexing unit 1121 (step S1409).

The rate control unit 1113 checks whether the notification that 33 msec has elapsed has been received from the timer 1130 (step S1411). If the notification has been received (step S1411:YES), processing moves to step S1421, and subsequent processing is executed. If the notification has not been received (step S1411:NO), the rate control unit 1113 judges whether the amount of data that has been multiplexed exceeds the predetermined value (step S1413).

If the amount of multiplexed data does not exceed the predetermined value (step S1413:NO), processing returns to step S1403, and subsequent processing is executed. If the amount of multiplexed data has exceeded the predetermined value (step S1413:YES), the rate control unit 1113 notifies the A/V multiplexing unit 1120 to suppress multiplex processing.

The video encoder 1112 encodes video input from the camera 1170 (step S1415). Thereafter, the audio encoder 1111 encodes audio input from the microphone 1160 (step S1417). The rate control unit 1113 then checks if the notification that 33 msec has elapsed has been received from the timer 1130 (step S1419).

If the notification has not been received (step S1419:NO), processing returns to step S1415, and subsequent processing is executed.

If the notification has been received (step S1419:YES), the rate control unit 1113 notifies the A/V multiplexing unit 1120 to suppress multiplex processing, the timer 1130 resets the count to 33 msec (step S1421), processing returns to step S1401, and subsequent processing is executed.

This processing is repeatedly executed as long as audio is input from the microphone 1160 and video is input from the camera 1170.

Operations of the Demultiplexer

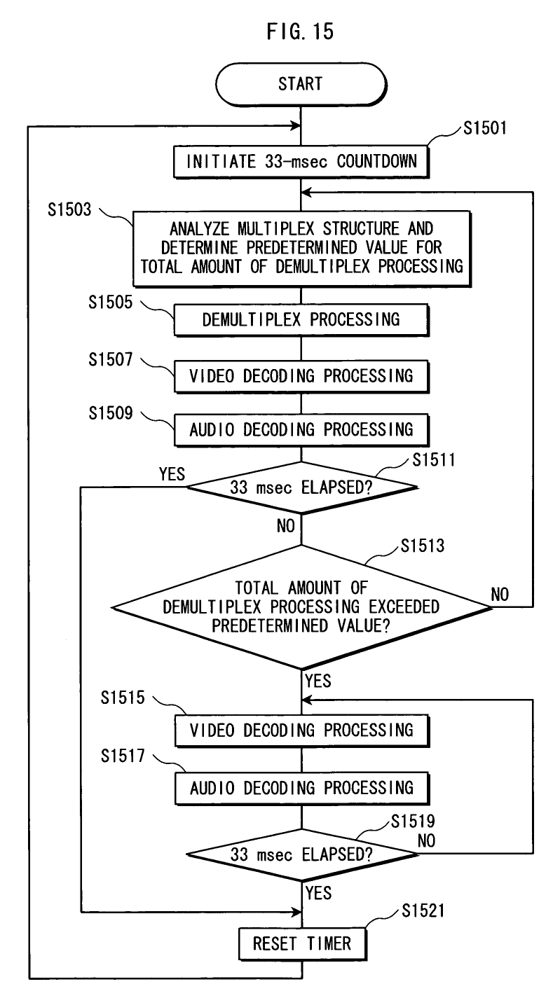

FIG. 15 is a flowchart showing operations of the demultiplexer 1200 pertaining to embodiment 3.

The demultiplexer 1200 receives multiplexed data from a multiplexer or the like, via the reception unit 1220. The received multiplexed data is sequentially accumulated in the buffer 1241.

The timer 1210 initializes a 33-msec countdown (step S1501). The multiplex structure analysis unit 1270 monitors the signal line connecting the reception unit 1220 and the buffer 1241, analyzes a structure of the multiplexed data being transmitted, and, based on the analyzed structure, calculates an amount of data that may be demultiplexed in 33 msec (step S1503). The rate control unit 1231 then sets, as the predetermined value, the data amount calculated by the multiplex structure analysis unit 1270.

The A/V demultiplexing unit 1240 then demultiplexes the multiplexed data in the buffer 1241 into video data and audio data, beginning with a head of the multiplexed data accumulated in the buffer 1241 (step S1505).

The encoded video data resulting from the demultiplex processing is decoded by the video decoder 1233 (step S1507). Also, the encoded audio data is decoded by the audio decoder 1232 (step S1509).

The rate control unit 1231 then checks whether the notification that 33 msec has elapsed has been received from the timer 1210 (step S1511). If the notification has been received (step S1511:YES), the timer 1210 resets the count to 33 msec (step S1521), processing returns to step S1501, and subsequent processing is executed.

If the notification has not been received (step S1511:NO), the rate control unit 1231 judges whether the total amount of demultiplexed data has exceeded the predetermined value (step S1513). If the predetermined value has not been exceeded (step S1513:NO), processing returns to step S1503, and subsequent processing is executed. If the predetermined value has been exceed (step S1513:YES), the rate control unit 1231 notifies the A/V demultiplexing unit 1240 to suppress demultiplex processing. The video decoder 1233 then decodes the video data (step S1515). Also, the audio decoder 1232 decodes the audio data (step S1517).

The rate control unit 1231 checks whether the notification that 33-msec has elapsed has been received from the timer 1210 (step S1519). If the notification has not been received (step S1519:NO), processing returns to step. S1515, and subsequent processing is executed. If the notification has been received (step S1519:YES), the rate control unit 1231 notifies the A/V demultiplexing unit 1240 to suppress demultiplex processing, the timer 1210 resets the count to 33 msec (step S1521), processing returns to step S1501, and subsequent processing is executed.

This processing is repeatedly executed as long as the multiplexed data is accumulated in the buffer 1241.

### Embodiment 4

Embodiment 4 is a variation of embodiments 2 and 3. In embodiment 4, times for multiplex processing and demultiplex processing are determined based on a structure of data targeted for the respective processing, and multiplex processing and demultiplex processing are restricted according to total processor occupancy times for each of the processing.

Structure

Structure of a Multiplexer

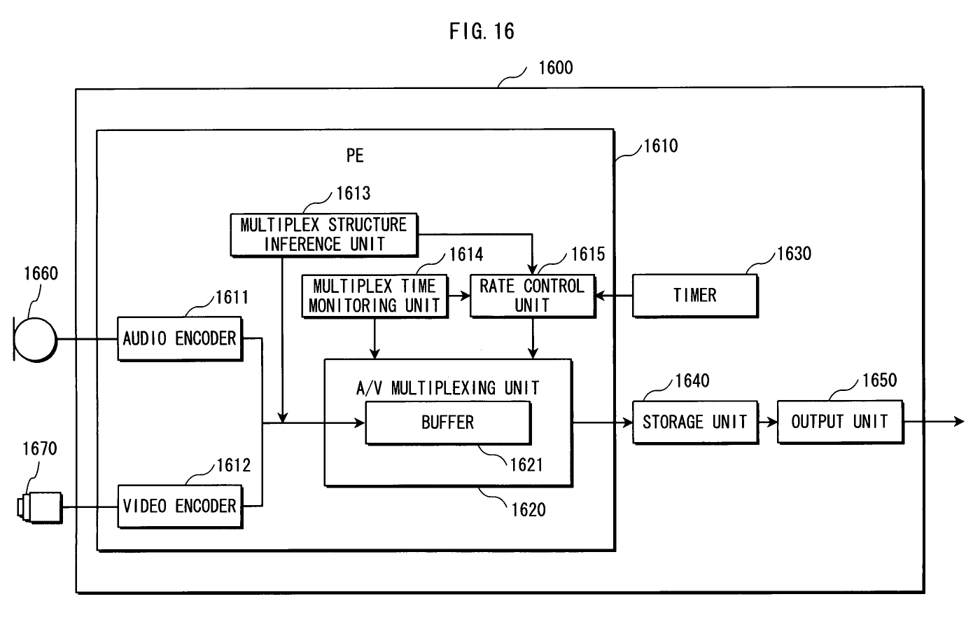

FIG. 16 is a block diagram showing a functional structure of a multiplexer 1600 pertaining to embodiment 4.

The structure of the multiplexer 1600 is a combination of the multiplexer 700 of embodiment 2 and the multiplexer 1100 of embodiment 3.

A multiplex structure inference unit 1613 infers a structure of data to be multiplexed, and determines a multiplex processing time based on the inferred structure. A method for making this determination is the same as in embodiment 3. The multiplex structure inference unit 1613 notifies the determined multiplex processing time to a rate control unit 1615.

A multiplex time monitoring unit 1614 monitors a total time for which an A/V multiplexing unit 1620 performed multiplex processing, and notifies the total time to the rate control unit 1615.

The rate control unit 1615 sets the multiplex processing time notified by the multiplex structure inference unit 1613 as a predetermined value. If the total time notified by the multiplex time monitoring unit 1614 exceeds the predetermined value, the rate control unit 1615 notifies the A/V multiplexing unit 1620 to suppress multiplex processing. Suppression of multiplex processing is cancelled when a notification that 33 msec has elapsed is received from a timer 1630.

Note that other structure elements have the same functions as those in the multiplexer of embodiments 1, 2 and 3, and descriptions thereof have been omitted.

Structure of a Demultiplexer

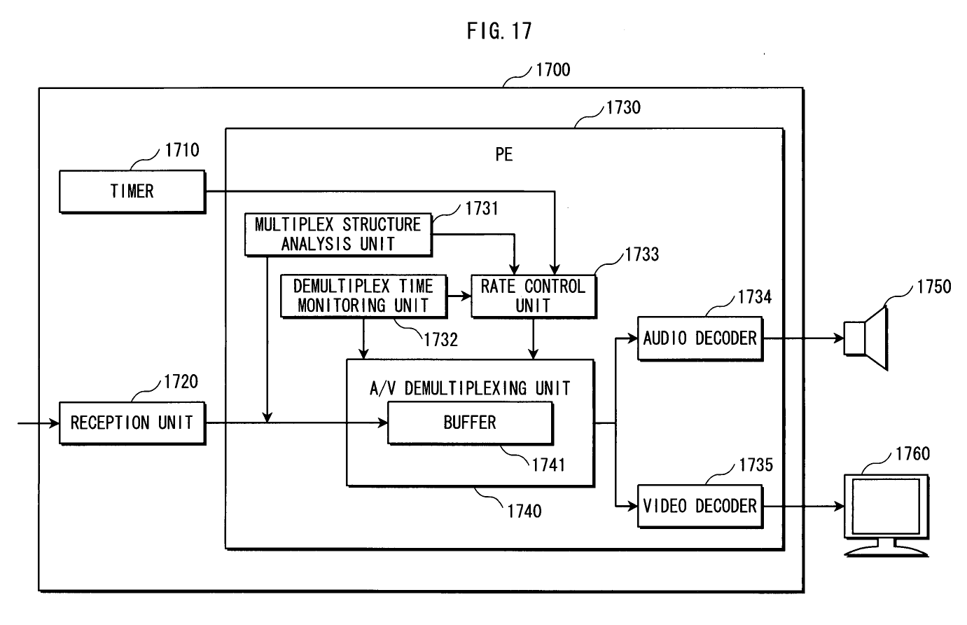

FIG. 17 is a block diagram showing a functional structure of a demultiplexer 1700 pertaining to embodiment 4.

Unlike the demultiplexer 200, the demultiplexer 1700 further includes a multiplex structure analysis unit 1731 and a demultiplex time monitoring unit 1732.

The multiplex structure analysis unit 1713 has the same functions as the multiplex structure analysis unit 1270 in embodiment 3. However, unlike the multiplex structure analysis unit 1270 which notifies the total data processing amount for each 33-msec period, the multiplex structure analysis unit 1731 notifies a total processing time for each 33-msec period as a predetermined value to be stored by a rate control unit 1733.

The rate control unit 1733 sets the total processing time notified from the multiplex structure analysis unit 1731 as the predetermined value, and suppresses demultiplex processing if the total time for demultiplex processing performed by an A/V demultiplexing unit 1740 exceeds the predetermined value.

Note that other structure elements have the same functions as those in the demultiplexer of embodiments 1, 2 and 3, and descriptions thereof have been omitted.

Operations

Operations of the Multiplexer

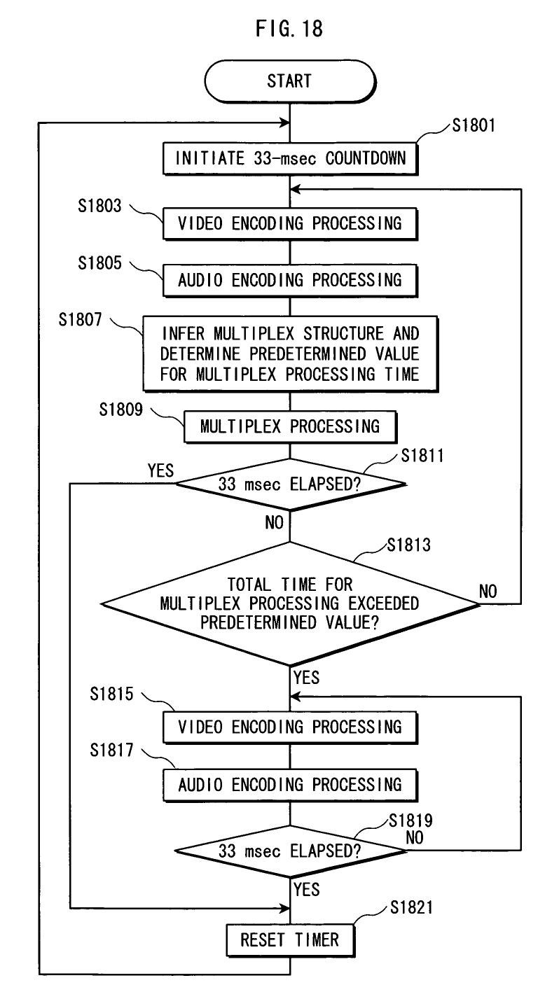

FIG. 18 is a flowchart showing operations of the multiplexer 1600.

The multiplexer 1600 acquires audio from a microphone 1660 and video from a camera 1670. At the same time, a timer 1630 initiates a 33-msec countdown timer (step S1801).

The acquired video is encoded by a video encoder 1612 to generate encoded video data (step S1803). Next, the audio acquired from the microphone is encoded by an audio encoder 1611 to generate encoded audio data (step S1805). The encoded video data and audio data are then accumulated in a buffer 1621. The multiplex structure inference unit 1613 monitors a signal line connecting the audio encoder 1611 and the video encoder 1612 to the buffer 1621, infers a structure of the data to be multiplexed, and calculates the multiplex processing time (step S1807). The calculated multiplex processing time is then set in the rate control unit 1615 as the predetermined value. The data accumulated in the buffer 1621 is multiplexed by the A/V multiplexing unit 1620 (step S1809).

The rate control unit 1615 checks whether the notification that 33 msec has elapsed has been received from the timer 1630 (step S1811). If the notification has been received (step S1811:YES), processing moves to step S1821, and subsequent processing is executed. If the notification has not been received (step S1811:NO), the rate control unit 1615 judges whether the total processing time for multiplex processing exceeds the predetermined value (step S1813).

If the total processing time for multiplex processing does not exceed the predetermined value (step S1813:NO), processing returns to step S1803, and subsequent processing is executed. If the total processing time for multiplex processing has exceeded the predetermined value (step S1813:YES), the rate control unit 1615 notifies the A/V multiplexing unit 1620 to suppress multiplex processing.

The video encoder 1612 encodes video input from a camera 1670 (step S1815). Thereafter, the audio encoder 1611 encodes audio input from a microphone 1660 (stepS1817). The rate control unit 1615 then checks if the notification that 33 msec has elapsed has been received from the timer 1630 (step S1819).

If the notification has not been received (step S1819:NO), processing returns to step S1815, and subsequent processing is executed.

If the notification has been received (step S1819:YES), the rate control unit 1615 notifies the A/V multiplexing unit 1620 to suppress multiplex processing, the timer 1630 resets the count to 33 msec (step S1821), processing returns to step S1801, and subsequent processing is executed.

This processing is repeatedly executed as long as audio is input from the microphone 1660 and video is input from the camera 1670.

Operations of the Demultiplexer

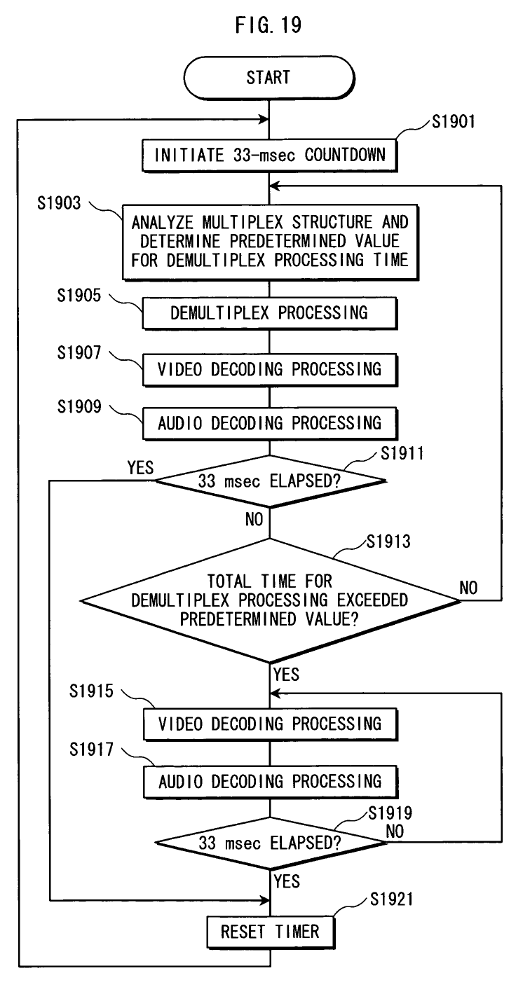

FIG. 19 is a flowchart showing operations of the demultiplexer 1700.

The demultiplexer 1700 receives multiplexed data from a multiplexer or the like, via a reception unit 1720. The received multiplexed data is sequentially accumulated in a buffer 1741.

A timer 1710 initializes a 33-msec countdown (step S1901). A multiplex structure analysis unit 1731 monitors a signal line connecting the reception unit 1720 and the buffer 1741, analyzes a structure of the multiplexed data being transmitted, and, based on the analyzed structure, calculates a total time for demultiplex processing may be performed in 33 msec (step S1903). A rate control unit 1733 then sets, as the predetermined value, the calculated demultiplex processing time.

The A/V demultiplexing unit 1740 then demultiplexes the multiplexed data in the buffer 1741 into encoded video data and audio data, beginning with a head of the multiplexed data accumulated in the buffer 1741 (step S1905).

The demultiplexed video data is decoded by a video decoder 1735 (step S1907). Also, the demultiplexed audio data is decoded by the audio decoder 1734 (step S1909).

The rate control unit 1733 then checks whether the notification that 33 msec has elapsed has been received from the timer 1710 (step S1911). If the notification has been received (step S1911:YES), the timer 1710 resets the count to 33 msec (step S1921), processing returns to step S1901, and subsequent processing is executed.

If the notification has not been received (step S1911:NO), the rate control unit 1733 judges whether the total time for demultiplex processing has exceeded the predetermined value (step S1913) If the predetermined value has not been exceeded (step S1913:NO), processing returns to step S1903, and subsequent processing is executed. If the predetermined value has been exceeded (step S1913:YES), the rate control unit 1733 notifies the A/V demultiplexing unit 1740 to suppress demultiplex processing. The video decoder 1735 then decodes the video data (step S1915). Also, the audio decoder 1734 decodes the audio data (step S1917).

The rate control unit 1733 checks whether the notification that 33-msec has elapsed has been received from the timer 1710 (step S1919). If the notification has not been received (step S1919:NO), processing returns to step S1915, and subsequent processing is executed. If the notification has been received (step S1919:YES), the timer returns to step S1901, and subsequent processing is executed.

This processing is repeatedly executed as long as multiplexed data is accumulated in the buffer 1741.

Supplementary Remarks

Although a multiplexer and a demultiplexer including a processor pertaining to the present invention have been described based on the above-mentioned embodiments 1 to 4, the embodiments of the present invention are not limited to these. Variations of these embodiments are described below.

(1) Although a multiplexer and a demultiplexer that include the processor pertaining to the present invention are disclosed in the above embodiments, the present invention may be any processor that executes processing using a round-robin method in an integrated system, and restricts certain processing when a total processing amount of such processing (in the above embodiments, multiplexing and demultiplexing) exceeds a predetermined value in a predetermined time (in the above embodiments, 33 msec).

For example, in a computing apparatus there may be a processor that executes a predetermined operation as a first processing, and executes another operation using the result of the first processing, as a second processing. In this case, the predetermined operation of the first processing involves receiving sequential data to execute a sequential operation. Also, the second processing need only use the result of the first processing to perform the second processing operation before a buffer storing the result of the first processing overflows.

(2) Although multiplex processing and demultiplex processing are restricted within a time period of 33 msec in the above embodiments, the time period need not be 33 msec. For example, the time period may be 60 msec, or set differently for each instance. Although multiplex processing and demultiplex processing are given a wide and lenient time span compared with the encoding and decoding of audio and video, the multiplex and demultiplex processing may be set such that they are restricted so as to be finished within the time span.

(3) Although the present invention is described in the above embodiments as a processor of an integrated system, a multiplexer and a demultiplexer may store a program that executes the present invention, and may read and execute the program.

(4) Although whether the notification that 33 msec has elapsed has been received from the timer is judged in the operation flows of the above embodiments, the present invention may be in a constant state for receiving the notification from the timer. If the notification is received, interrupt processing may be performed, and multiplex or demultiplex processing may again be executed from that point.

(5) Although a single processing operation is restricted within a given time span (in the above embodiments, 33 msec) in the round-robin method in the above embodiments, processing may be executed according to priority.

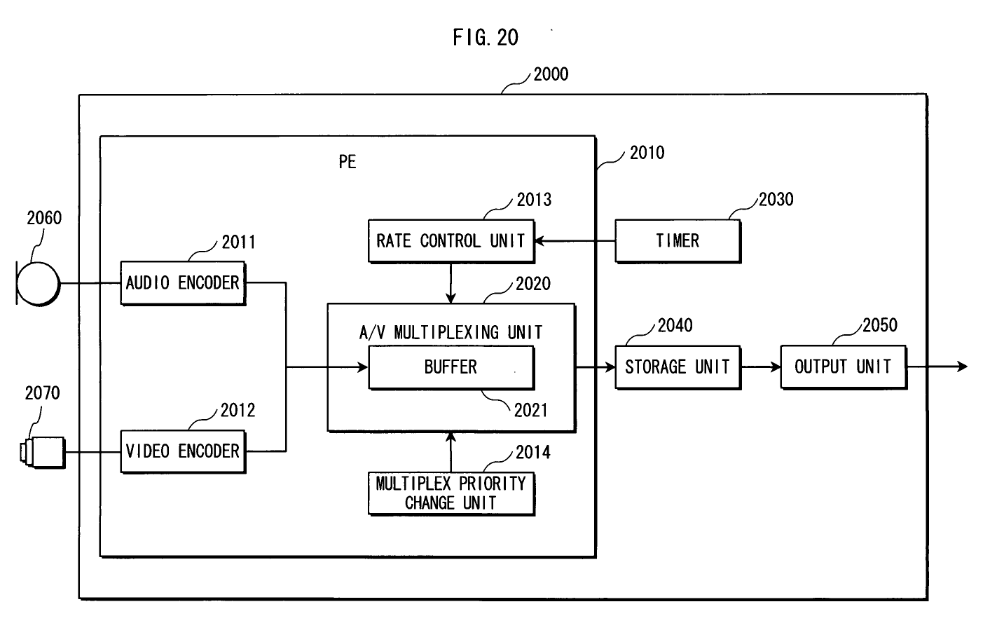

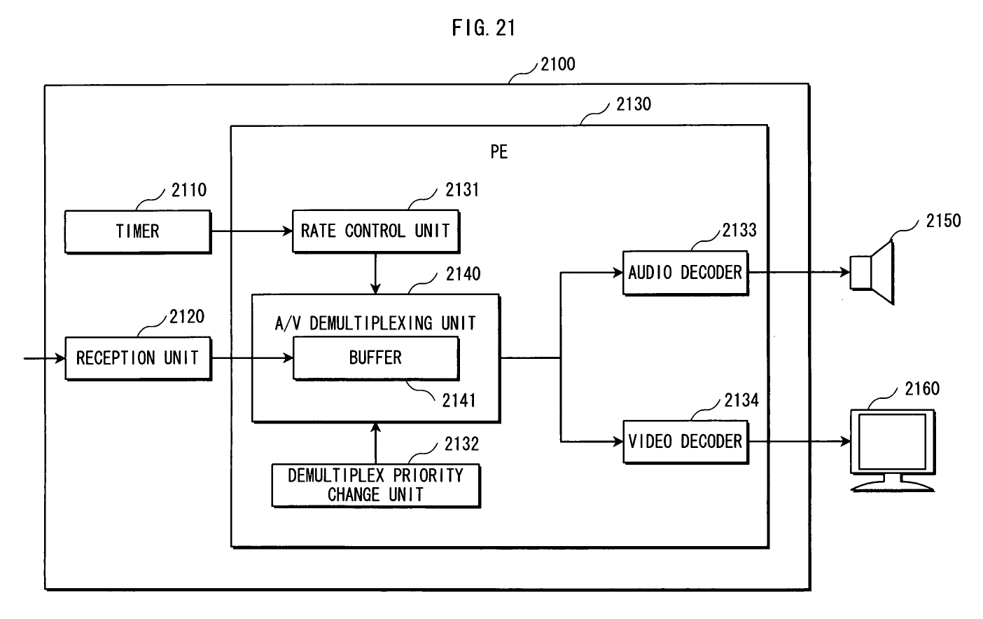

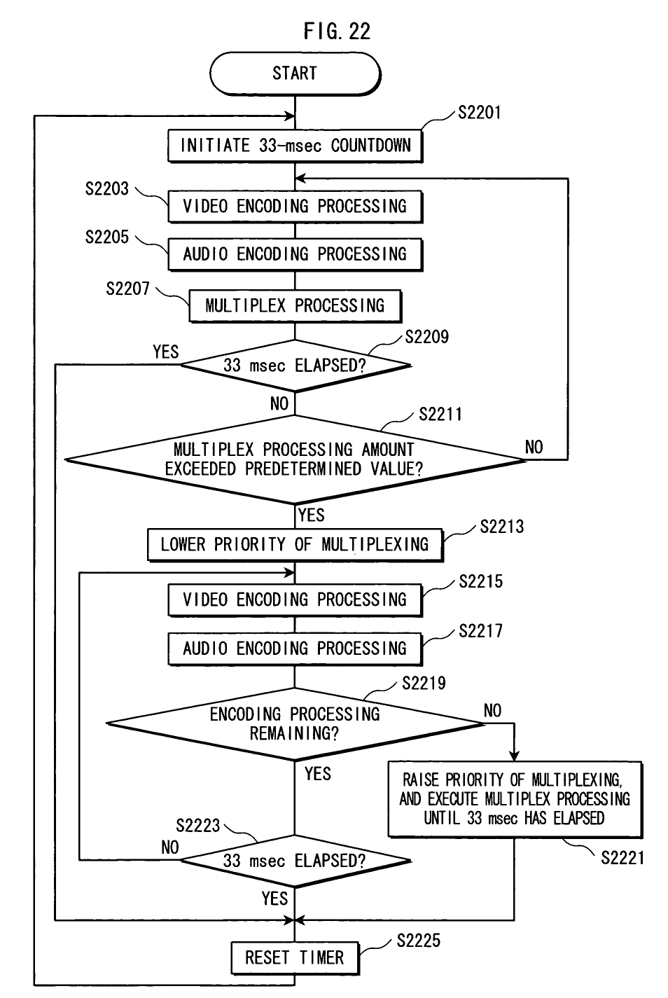

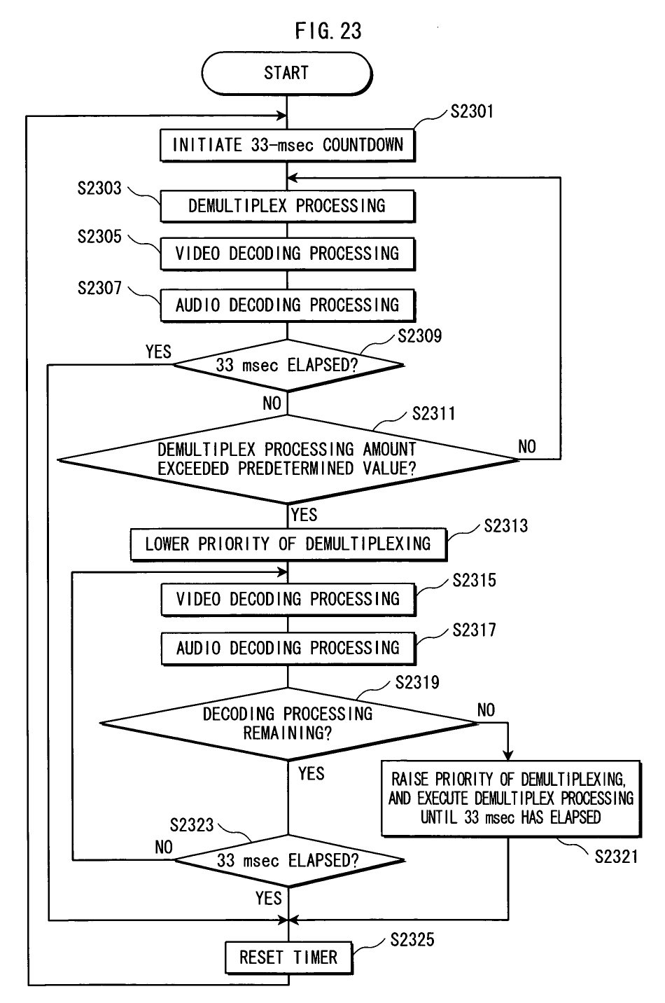

FIG. 20 shows a structure of a multiplexer, and FIG. 21 shows a structure of a demultiplexer, pertaining to the above case. FIG. 22 is a flowchart showing operations of the multiplexer, and FIG. 23 is a flowchart showing operations of the demultiplexer.

The following briefly describes these figures.

As shown in FIG. 20, a multiplexer 2000 includes a multiplex priority change unit 2014, unlike the multiplexer 100. An execution priority is determined for audio encoding processing, video encoding processing, and multiplex processing. Note that the processing priorities are set according to the preference of a designer. Here, each of the processing priorities has been set to “1”.

If the multiplex processing amount exceeds a predetermined value in 33 msec, the multiplex priority change unit 2014 sets the execution priority of the multiplex processing to “0”. The multiplex processing ceases to be performed when its execution priority is set to “0”. The execution priority of the multiplex processing is again set to “1” when the notification that 33 msec has elapsed is received from the timer, and the multiplex processing is thus again executed.

Also, if no encoding processing is present after the multiplex processing priority has been set to “0” and before 33 msec has elapsed, that is to say, if there ceases to be audio input or video input from a microphone 2060 or a camera 2070, suppression of the multiplex processing in the 33 msec period is cancelled (i.e., the multiplex processing priority is reset to “1”), and the multiplex processing is executed.

Unlike the demultiplexer 200, the demultiplexer 2100 includes a demultiplex priority change unit 2132 that changes the priority of demultiplex processing. Demultiplex processing, audio decoding processing and video decoding processing are all fundamentally set with a priority of “1”.

The demultiplex priority change unit 2132 sets the priority of demultiplex processing to “0” if the demultiplex processing amount exceeds a predetermined value in a 33-msec period, and resets the priority to “1” after the 33-msec period has elapsed. The demultiplex processing is not executed while its priority is set to “0”, and video decoding processing and audio decoding processing are executed instead.

Also, if no audio decoding processing or video decoding processing is present after the demultiplex processing priority has been set to “0” in the 33-msec period, the demultiplex priority change unit 2132 resets the demultiplex processing priority to “1” for a remainder of the 33-msec period.

Processing of the demultiplexer 2100 is shown in the flowchart of FIG. 23.

The demultiplexer 2100 also sets the priorities of demultiplex processing, audio decoding processing and video decoding processing, and restricts the demultiplexing decoding processing, and restricts the demultiplexing processing in a 33-msec period if the demultiplex processing amount exceeds a predetermined amount. This restriction, however, is performed according to the priority settings, and the demultiplex processing is no longer performed since other processing, that is to say, audio decoding processing and video decoding processing, have a higher priority than the demultiplex processing.

(6) Although the ratio of video encoding processing to audio encoding processing to multiplex processing is set to 6:3:1 in the above embodiments, the ratio is not limited to this. Another ratio may be used. The ratio of these processing operations is set by the producer of the multiplexer.

The demultiplexer is similar in this regard, and the ratio of processing operations is not limited to the ratio in the above embodiments.

(7) The present invention may be realized as methods for performing the above-described functions. Also, the present invention may be realized as a computer program for causing a computer to operate by the methods. Also, the present invention may be realized as digital signals representing the computer program.

The present invention may be realized as a computer-readable recording medium (for example, a flexible disk, a hard disk, CD-ROM, MO, DVD, DVD-ROM, DVD-RAM, BD (Blu-ray Disc), or a semiconductor memory) containing the above computer program or digital signals recorded thereon. program or the digital signals recorded on the computer-readable recording medium.

The present invention may be realized as a computer system including a CPU and a memory, where the memory stores the computer program, and the CPU operates in accordance with the computer program.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

### INDUSTRIAL APPLICABILITY

A multiplexer pertaining to the present invention can be utilized in a digital video camera, DVD recorder, or the like, and a demultiplexer pertaining to the present invention can be utilized in a DVD player.

What is claimed is:

1. A processor comprising:
a storage unit operable to store data to be processed;
an execution unit operable to cyclically and sequentially execute first processing and second processing that have been allocated respective unit times, each instance of the first processing and the second processing being executed continually for a maximum of the respective allocated unit time, and the second processing being executed only if the data to be processed is stored in the storage unit; and
a control unit operable, after a total value of a processing amount of the second processing has exceeded a predetermined value in a predetermined time period that is longer than each of the unit times, to suppress execution of the second processing in the predetermined time period and control the execution unit to execute the first processing in place of executing the second processing.

2. The processor of claim 1, wherein in performing the suppression, the control unit uses a total data amount of the second processing that has been processed by the execution unit, as the total value of the processing amount.

3. The processor of claim 1, further comprising:
a monitoring unit operable, when the second processing is being executed by the execution unit, to monitor a total time for which the second processing is executed in the predetermined time period, wherein
in performing the suppression, the control unit uses the total time monitored by the monitoring unit, as the total value of the processing amount.

4. The processor of claim 1, further comprising:
a video encoding unit operable to receive an input of video, and encode the video to generate video data; and
a multiplex unit operable to multiplex the generated video data with other data, wherein
the first processing includes video encoding processing, and
the second processing includes multiplex processing.

5. The processor of claim 4, further comprising:
an audio encoding unit operable to receive an input of audio, and encode the audio to generate audio data, wherein
the other data is the generated audio data.

6. The processor of claim 5, further comprising:
an inference/determination unit operable to infer a data structure of data to be multiplexed by the multiplex unit, and determine the predetermined value according to the inferred data structure, wherein
the control unit suppresses the multiplex processing in the predetermined time if a total amount of the multiplex processing executed by the multiplex unit exceeds, in the predetermined time period, the predetermined value determined by the inference/determination unit.

7. The processor of claim 5, further comprising:
a priority determination unit operable to determine a priority for each of processing executed by the audio encoding unit, the video encoding unit and the multiplex unit, wherein
if a total amount of the multiplex processing executed by the multiplex unit exceeds the predetermined value, the priority determination unit lowers the priority of the multiplex processing, and the control unit suppresses the multiplex processing according to the priorities determined by the priority determination unit.

8. The processor of claim 1, further comprising:
a demultiplex unit operable to receive multiplexed data, and demultiplex the received multiplexed data into video data and other data; and
a video decoding unit operable to receive the video data, and decode the received video data, wherein
the first processing includes video decoding processing, and
the second processing includes demultiplex processing.

9. The processor of claim 8, further comprising:
an audio decoding unit operable to receive audio data, and decode the received audio data, wherein
the other data includes the audio data, and
the first processing includes audio decoding processing.

10. The processor of claim 9, further comprising:
an analysis/determination unit operable to analyze a data structure of the multiplexed data to be demultiplexed by the demultiplex unit, and determine the predetermined value according to the analyzed data structure, wherein
the control unit suppresses the demultiplex processing in the predetermined time period if a total amount of the demultiplex processing executed by the demultiplex unit exceeds, in the predetermined time period, the predetermined value determined by the analysis/determination unit.

11. The processor of claim 9, further comprising:
a priority determination unit operable to determine a priority for each of processing executed by the audio decoding unit, the video decoding unit and the demultiplex unit, wherein
if a total amount of the demultiplex processing executed by the demultiplex unit exceeds the predetermined value, the priority determination unit lowers the priority of the demultiplex processing, and the control unit suppresses the demultiplex processing according to the priorities determined by the priority determination unit.

12. The processor of claim 1, wherein, if the first processing is not present after the second processing has been suppressed in the predetermined time period, the control unit cancels the suppression and executes the second processing in the predetermined time period.

13. A processing method in a processor that executes a plurality of processing operations, the processing method comprising:
a storage step of storing data to be processed;
an execution step of cyclically and sequentially executing first processing and second processing that have been allocated respective processor occupancy times, each instance of the first processing and the second processing being executed for a maximum of the respective allocated processor occupancy time, and the second processing being executed only if the data to be processed is stored in the storage step; and
a control step of, after a total value of a processing amount of the sequentially executed second processing has exceeded a predetermined value in a predetermined time period, suppressing execution of the second processing in the predetermined time period and performing control such that the first processing is executed in place of execution of the second processing.

14. A processing program indicating a processing procedure for causing a processor to execute a plurality of processing, the processing procedure comprising:
a storage step of storing data to be processed;
an execution step of cyclically and sequentially executing first processing and second processing that have been allocated respective processor occupancy times, each instance of the first processing and the second processing being executed for a maximum of the respective allocated processor occupancy time, and the second processing being executed only if the data to be processed is stored in the storage step; and
a control step of, after a total value of a processing amount of the sequentially executed second processing has exceeded a predetermined value in a predetermined time period, suppressing execution of the second processing in the predetermined time period and performing control such that the first processing is executed in place of execution of the second processing.
